(19) United States
(12) Patent Application Publication
(10) Pub. No.: US 2024/0348928 A1
(43) Pub. Date: Oct. 17, 2024

(54) IMAGE DISPLAY METHOD, DEVICE AND ELECTRONIC DEVICE FOR PANORAMA SHOOTING TO IMPROVE THE USER'S VISUAL EXPERIENCE

(71) Applicant: Arashi Vision Inc., Shenzhen (CN)

(72) Inventor: Shun WAN, Shenzhen (CN)

(73) Assignee: Arashi Vision Inc., Shenzhen (CN)

(21) Appl. No.: 18/756,028

(22) Filed: Jun. 27, 2024

Related U.S. Application Data
(63) Continuation of application No. PCT/CN2022/141781, filed on Dec. 26, 2022.

(30) Foreign Application Priority Data
Dec. 29, 2021 (CN) 202111642147.7

(51) Int. Cl. H04N 23/698; H04N 23/63

(52) U.S. Cl. CPC H04N 23/698; H04N 23/635

(57) ABSTRACT

The embodiment of the present application provides an image display method, device and electronic device. The method can be applied to an electronic device, and the method comprises: displaying a first image window, the first image window is used to display a first picture, which can be a partial picture of a panoramic image; displaying a second image window, the second image window is used to display a second picture, which can be a partial picture or a whole picture of the panoramic image. There is content difference between the second picture and the first picture. According to the method of the embodiment of the present application, the visual experience of the user can be improved.

### CROSS-REFERENCE TO RELATED APPLICATIONS

This application is a continuation of International Application No. PCT/CN2022/141781, with an international filing date of Dec. 26, 2022, which is based upon and claims priority to Chinese Patent Application No. 202111642147.7, filed with the Chinese Patent Office on Dec. 29, 2021, titled “Image display method, device and electronic device”, the entire contents of each are incorporated herein by reference.

### TECHNICAL FIELD

The present application relates to the field of image processing, in particular to an image display method, device and electronic equipment.

### BACKGROUND

In the application scene of photography and videography, a shooting object is usually the scene within a shooting angle in front of the lens of the image acquisition device. The size of the shooting angle depends on the hardware parameters of the image acquisition device, and the scenery outside the shooting angle of the lens will not be captured. As a result, the image taken by the image acquisition device can only show the scenery in one direction from the shooting point, and the scenery in other directions from the shooting point will be omitted. In order to avoid missing the scenery around the shooting point as much as possible, in the application scene of photography and videography, a panoramic shooting scheme is proposed.

Panoramic shooting refers to horizontal 360-degree and vertical 180-degree shooting with the shooting point as the center. A panoramic shooting image may be an image with a length to width ratio of 2:1, which is spliced from images acquired at shooting angles of 360 degrees horizontally and 180 degrees vertically, centered on the shooting point. The panoramic shooting image can include the scenery in all directions around the shooting point, so as to avoid missing the surrounding scenery of the shooting point.

Although the panorama image can include the scenery in all directions around the shooting point, however, because the image aspect ratio of the panorama image is fixed, when displaying the panorama image, the panorama image may not be compatible with the size of the display screen of the display device, the size of the application display window, or the viewing angle habits of viewers. This may lead to the reduction of the user's visual experience.

Therefore, there is a need for an image display method for panorama shooting to improve the user's visual experience.

### BRIEF SUMMARY

Aiming at solving the problem of the unsatisfactory user's visual experience in the display process of the panorama shot image, the present application provides an image display method, device and electronic device, and the present application also provides a computer-readable storage medium.

In accordance with various embodiments, the following technical solutions can be adopted.

In one embodiment, an image display method can be applied to an electronic device, and the method can comprise: displaying a first image window, the first image window is used to display a first picture, and the first picture is a partial frame of a panoramic shot image; and displaying a second image window, the second image window is used to display a second picture, the second picture is a part or the whole picture of the panoramic shot image, and wherein there is content difference between the second picture and the first picture.

In one embodiment, on the panoramic shot image, the corresponding area of the second picture includes the corresponding area of the first picture.

In one embodiment, the second picture is a whole frame of the panoramic shot image.

In one embodiment, a corresponding area of the first picture is marked in the second picture.

In one embodiment, the second image window is smaller than the first image window, and the second image window is displayed floatingly above the first image window.

In one embodiment, the first image window is a full-screen display window.

In one embodiment, the method further comprises transforming the image content of the first picture according to the user's perspective transformation operation.

In one embodiment, the device is installed in an electronic device, the electronic device includes a display module, and the device comprises: a first display driving module, which is used to drive the display module to display a first image window, the first image window is used to display a first picture, and the first picture is a partial picture of a panoramic shot image; and a second display driving module, which is used to drive the display module to display a second image window, the second image window is used to display a second picture, and the second picture is a part of the picture or the whole picture of the panoramic shot image, wherein there is content difference between the second picture and the first picture.

In one embodiment, an electronic device includes a memory for storing computer program instructions, a processor for executing computer program instructions, and a display device, wherein when the computer program instructions are executed on the processor, the electronic device can be triggered to execute the method steps in the various embodiments.

In accordance with various embodiments, a computer program can be stored in a computer-readable storage medium, and when the computer program is run on a computer, it can cause the computer to execute the method provided in various embodiment described in the present application.

Accordingly, the user's visual experience can be improved.

### DESCRIPTION OF THE DRAWINGS

FIG. 1 is an exemplary flowchart of an image display method according to an embodiment of the present application.

FIG. 2 shows an exemplary execution flow according to an embodiment of the present application.

FIG. 3 is an exemplary block diagram of a device structure according to an embodiment of the present application.

FIG. 4 is an exemplary schematic structural diagram of an electronic device according to an embodiment of the present application.

### DETAILED DESCRIPTION

The described embodiments are only some of the embodiments of the present application, rather than all the embodiments. Various terms used in the embodiments of the present application are only used to explain specific embodiments and are not intended to limit the present application.

Aiming at solving the problem of unsatisfactory user's visual experience in the process of displaying panoramic images, an image display method can be provided. In an embodiment, the display device displays a first image window, and displays a first picture in the first image window, where the first picture is a partial image of a panoramic shot image. The size of the first picture can match the size of the display picture of the display device, and the first picture can match the viewing angle habit of the user, thereby improving the user's visual experience.

Furthermore, since the first picture is a partial image of the panoramic shot image, the display device cannot provide all image information of the panoramic shot image based only on the first picture. In order to increase the image information that can be displayed by the display device, the display device also displays a second image window, in which a second picture is displayed, and the second picture is a partial or full image of the panoramic shot image.

There is content difference between the second picture and the first picture, and the user can obtain image information not displayed in the first picture through the second picture, so that the display device can improve the user's visual experience through both the first picture and the second picture. The second picture can increase the image information displayed by the display device.

In accordance with various embodiments, a display device can be an electronic device with a display screen, for example, a mobile phone, a notebook computer, a desktop computer, a tablet computer, a smart device with a display screen, and the like.

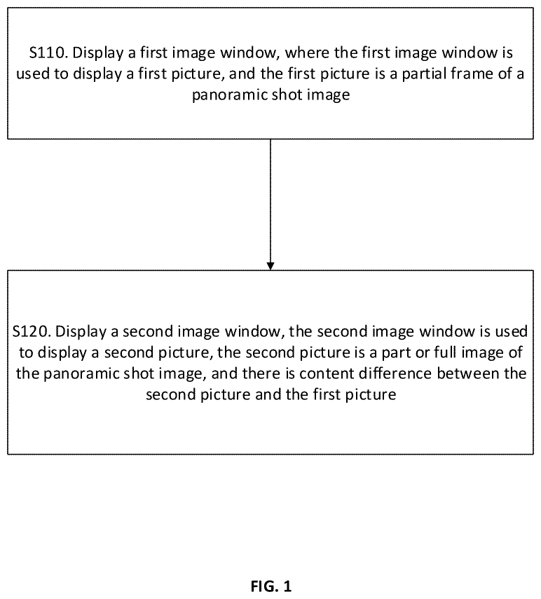

FIG. 1 is an exemplary flowchart of an image display method according to an embodiment. In accordance with various embodiments, the display device can execute the steps shown in FIG. 1 to realize the display of the panoramic shot image.
S110. Display a first image window, where the first image window is used to display a first picture, and the first picture is a partial frame of a panoramic shot image.
S120. Display a second image window, the second image window is used to display a second picture, the second picture is a part or full image of the panoramic shot image, and there is content difference between the second picture and the first picture.

In the embodiment of the present application, the size and shape parameters of the first picture are not specifically limited, and those skilled in the art can set the specific size and shape parameters of the first picture according to actual needs.

In an embodiment, the shape and size of the first picture may be determined according to the viewing angle habit of the user. For example, assuming that viewers are used to paying attention to the scenery within the viewing angle range of 60 degrees, left, right, up, down, and 80 degrees in front, according to the above viewing angle habits, the first picture can be set as a part of the panorama shooting image corresponding to the shooting angle of 60 degrees, left, right, up, down, and 80 degrees.

In another embodiment, the shape and size of the first picture may be determined according to the display requirements of the current application. For example, in an application scenario, it is simulated that the user views the scene through a monocular, so the first image window can be configured as a circular window, and the first picture is a circular picture matching the first image window. In another application scenario, it is simulated that the user views the scene through a square camera frame, so the first image window can be configured as a square window, and the first picture is a square frame matching the first image window.

In another embodiment, the shape and size of the first picture may be determined according to the size of the display picture of the display device. For example, in an application scenario, the first image window can be a full-screen display window of the display device, and the first picture is a picture that matches the size and shape of the first image window.

Furthermore, in various embodiments, there is no specific limitation on the image content of the first picture.

In an embodiment, a part of the frames in the panoramic shot image may be set as the first picture according to actual requirements. For example, in an application scenario, it is necessary to display marked partial images in the panoramic shot image, so the first picture is an image including the marked partial images in the panoramic shot image. For example, assuming that person A is marked in a certain panoramic shot image, in an implementation manner, the first picture can be a partial image including the person A in the panoramic shot image.

In another embodiment, a part of the screen selected by the user may be determined as the first screen according to the specified operation of the user. For example, in an application scenario, the user can perform a finger sliding operation in the first image window, and the image corresponding to the first screen can move according to the user's finger sliding direction, so that the screen content displayed on the first screen can change.

Furthermore, in accordance with various embodiments, there is no specific limitation on the specific size and shape parameters of the second picture, and those skilled in the art can set the specific size and shape parameters of the second picture according to actual needs.

In an embodiment, the shape and size of the second picture may be determined according to the habit of the user's viewing angle.

In another embodiment, the shape and size of the second picture may be determined according to actual requirements of the current application.

In another embodiment, the shape and size of the second picture may be determined according to the size of the display picture of the display device.

Furthermore, in accordance with various embodiments, there is no specific limitation on the specific size and shape parameters of the second picture, and those skilled in the art can set the specific size and shape parameters of the second picture according to actual needs.

In an embodiment, the shape and size of the second picture may be determined according to the habit of the user's viewing angle.

In another embodiment, the shape and size of the second picture may be determined according to actual requirements of the current application.

In another embodiment, the shape and size of the second picture may be determined according to the size of the display picture of the display device.

Furthermore, in accordance with various embodiments, there is no specific limitation on the image content of the second picture.

In an embodiment, the second picture is a whole frame of the panoramic shot image.

In another embodiment, a part of frames in the panoramic shot image may be set as the second picture according to actual needs.

In another embodiment, the part of the screen selected by the user may be determined as the first screen according to the specified operation of the user.

Furthermore, the second picture may be a picture including the first picture. For example, the first picture is part of the frame of person A in the panorama shot image. On the basis of not missing the frame information of person A, the first picture displays the frame of person A as enlarged as possible to provide the clearest frame of person A. The second picture includes the first picture, and the second picture provides more image content in the panoramic shot image than the first picture, so that the user can confirm the position of the person A in the panoramic shot image.

The second picture may also have a picture that is positionally associated with the first picture. For example, the viewing angle corresponding to the second picture and the viewing angle corresponding to the first picture are set to opposite viewing directions.

Furthermore, the second picture may also include image information other than the panoramic shot image.

For example, in an embodiment, the second picture is a full or part of the panoramic shot image. Additional image information (for example, image information such as shooting date, image resolution, etc.) can be superimposed and displayed on all or part of the panoramic shot image.

In another embodiment, the second picture includes the first picture. In the second picture, an image area mark can be displayed, and the image area mark can be used to mark an image range corresponding to the first picture in the second picture. For example, a bounding box can be added to the image range corresponding to the first picture in the second picture. In another example, the image range can be highlighted corresponding to the first picture in the second picture. Also, a color layer can be added to the corresponding image range.

In accordance with various embodiments, there is no specific limitation on the sources of the panoramic shooting images for the first picture and the second picture.

In an embodiment, the panoramic shot images for the first picture and the second picture are pre-captured still images.

In another embodiment, the panoramic shooting images targeted by the first picture and the second picture are panoramic shooting pictures monitoring current subject. Furthermore, in an embodiment, the panorama shot images targeted by the first picture and the second picture are frames of the panorama shot monitoring current subject. After the user performs a shooting operation (for example, clicking a shooting button), a snapshot can be taken on the content of the first picture.

In another embodiment, the panoramic shot images for the first picture and the second picture can be a frame of image in a pre-shot panoramic shot video. Furthermore, in an embodiment, the first picture and the second picture can be the display frames of the panoramic shooting video, and the panoramic shooting images targeted by the first picture and the second picture are current frames played by the panoramic shooting video.

Furthermore, the snapshot operation can be a function of, on the player page, clicking record, and synchronizing the currently playing display screen into a video file in real time. In an embodiment, in the process of playing the panorama shooting video based on the first picture and the second picture, when the user initiates a snapshot operation (for example, clicks a snapshot button), the content of the first picture can be snapped.

In accordance with various embodiments, exemplary implementation process of the image display method can be described below.

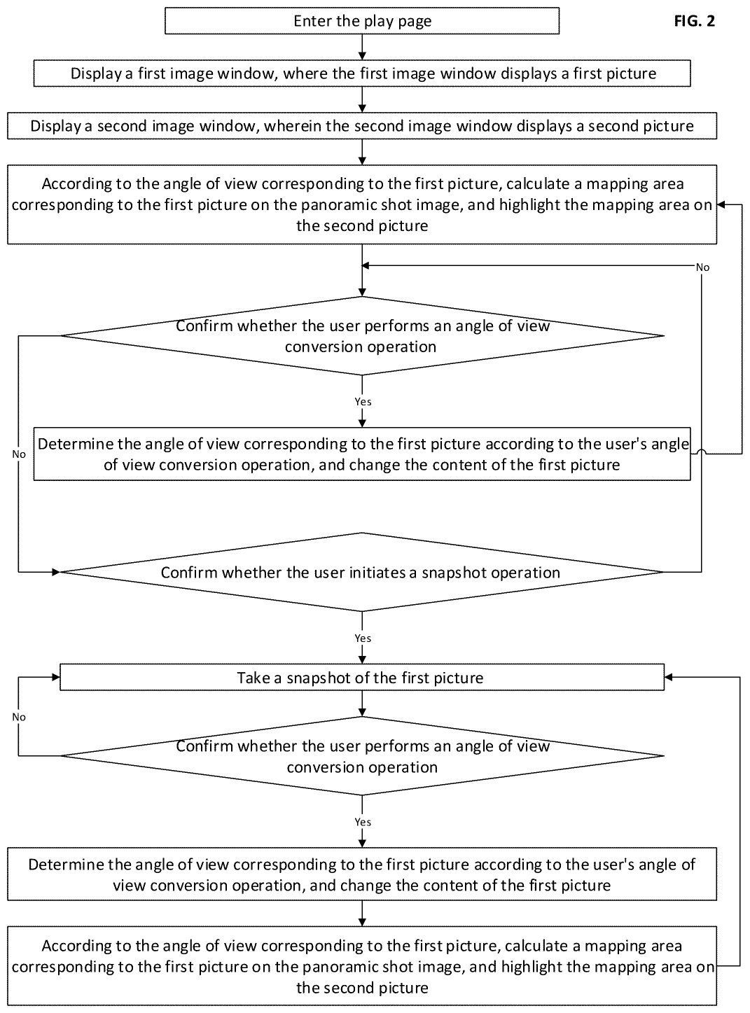

FIG. 2 shows an exemplary execution process according to an embodiment. As shown in FIG. 2, in an application scenario, the panoramic video display device can execute the following process.
S200. Enter the play page.
S211. Display a first image window, where the first image window displays a first picture.

The first image window can be a full-screen display window.

The first picture is a partial image of the currently playing frame (e.g., one frame of panoramic shooting image) of the currently playing panoramic shooting video.

In accordance with various embodiments, the images of the panoramic shooting video are equivalent to a sphere picture formed by splicing and rendering on a sphere, so that the center (shooting point) of the sphere picture has a 360-degree viewing angle. The panoramic shooting images of each frame of the panoramic shooting video can be spliced and rendered on a 2:1 picture, which is equivalent to the expansion of a spherical picture. The first picture is equivalent to projecting a partial region of the spherical frame corresponding to the image of the panorama shooting video (the shape and size of the region matches the first image window) to the first image window for display.
S212. Display a second image window, wherein the second image window displays a second picture.

The second image window can be superimposed on the upper right corner of the first image window.

The second picture is a whole frame of the currently playing frame (one frame of panoramic shooting image) of the currently playing panoramic shooting video.
S213. According to the angle of view corresponding to the first picture, calculate a mapping area corresponding to the first picture on the panoramic shot image, and highlight the mapping area on the second picture.

For example, latitude and longitude can be used to describe panoramic shooting video. For a certain frame of panoramic shooting image, such as an image with the coordinate origin at 2*pi×pi in the lower left corner of the screen, the range represented by longitude is [0-2*pi], and the range represented by latitude is [0-pi].
S220. Confirm whether the user performs an angle of view conversion operation (for example, the user slides a finger in the first image window).
S221. When the user performs an angle of view conversion operation, determine the angle of view corresponding to the first picture according to the user's angle of view conversion operation, and change the content of the first picture. Return to S213.

For example, the initial angles (sideslip (angle) yaw, inclination pitch, and rotation angle roll) of projecting the spherical image to the first image window can all be zero. Then, the new angle can be slid in real time according to the gesture (for example, slide the angle +/−5° once horizontally) to obtain.
S230. Confirm whether the user initiates a snapshot operation (for example, the user clicks a snapshot button).
S221. Take a snapshot of the first picture after the user starts the snapshot operation.
S240. During the snapshot process, confirm whether the user performs an angle of view conversion operation (for example, the user slides a finger in the first image window).
S241. When the user performs an angle of view conversion operation, determine the angle of view corresponding to the first picture according to the user's angle of view conversion operation, and change the content of the first picture.
S242. According to the angle of view corresponding to the first picture, calculate a mapping area corresponding to the first picture on the panoramic shot image, and highlight the mapping area on the second picture.

Furthermore, based on the methods of the above-mentioned embodiments, an image display device can be provided in an electronic device (such as a mobile phone) equipped with a display module, and each module in the device, under the control of the processing module of the device, can execute corresponding actions.

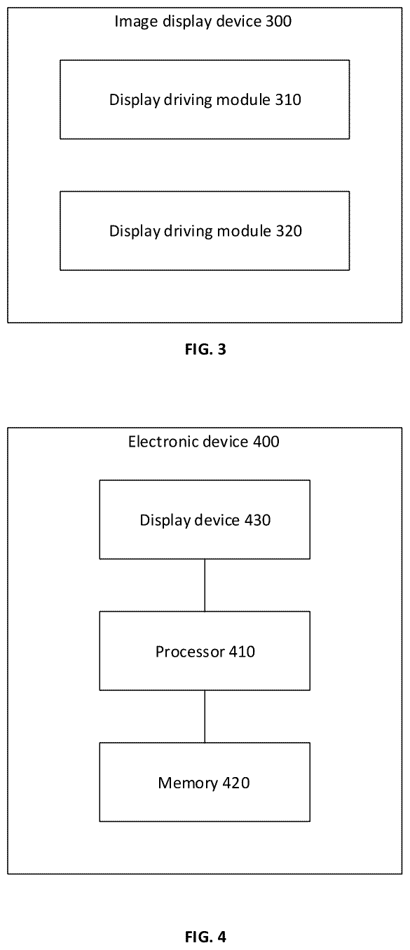

FIG. 3 is an exemplary structural block diagram of an image display device according to an embodiment. The image display device can be installed in an electronic device, and the electronic device includes a display module.

As shown in FIG. 3, the image display device 300 includes: a display driving module 310, which is used to drive the display module to display a first image window, the first image window is used to display a first picture, and the first picture is a partial picture of a panoramic shot image; and a display driving module 320, which is used to drive the display module to display a second image window, the second image window is used to display a second picture, and the second picture is part or all of the panoramic shot image, wherein there is content difference between the second picture and the first picture.

In the description of the various embodiments of the present application, for the convenience of description, when describing a device, the function(s) can be divided into various modules and described separately. The division of each module is only a division of logical functions. Ina accordance with various embodiments, the functions of various modules can be implemented using the same or more software and/or hardware.

In accordance with various embodiments, the devices described may be fully or partially integrated into a physical entity during actual implementation and may also be physically separated. Additionally, these modules can all be implemented in the form of software called by the processing element. These modules can also be implemented in the form of hardware; some modules can also be implemented in the form of software called by the processing clement, and some modules can be implemented in the form of hardware. For example, the determining module may be a separately established processing element or may be integrated into a certain chip of the electronic device for implementation. Other modules can be implemented in a similar fashion. In addition, all or part of these modules can be integrated together and can also be implemented independently. In the implementation process, each step of the above methods or each module above can be carried out by an integrated logic circuit of hardware in the processor element or by an instruction in the form of software.

For example, the above modules may be one or more integrated circuits configured to implement the above method, for example: one or more specific integrated circuits (Application Specific Integrated Circuit, ASIC), or, one or more digital signal processors (Digital Signal Processor, DSP), or, one or more Field Programmable Gate Arrays (Field Programmable Gate Array, FPGA), etc. For another example, these modules can be integrated together and implemented in the form of a device-on-a-chip (System-On-a-Chip, SOC).

Furthermore, based on the methods of the above embodiments, an electronic device (user terminal) can include a memory for storing computer program instructions, a processor for executing program instructions, and a display module, wherein, when the computer program instructions are executed by the processor, the electronic device can be triggered to perform S110, S120, and/or other actions performed by the electronic device (e.g., a display device) in the methods shown in the embodiments of the present application.

FIG. 4 is an exemplary schematic structural diagram of an electronic device (display device) according to an embodiment of the present application. In accordance with various embodiments, an electronic device (such as display device) may adopt the component structure as shown in FIG. 4. As shown in FIG. 4, an electronic device 400 can include a processor 410, a memory 420 and a display device 430.

The memory 420 may be used to store computer program instructions for executing the methods shown in the above embodiments. When the processor 410 executes the computer program instructions stored in the memory 420, the processor 410 controls the communication device 430 to execute the methods shown in the above embodiments.

The processor 410 of the electronic device 400 may be a device on chip SOC, and the processor may include a central processing unit (Central Processing Unit, CPU), and may further include other types of processors.

In accordance with various embodiments, the processor 410 may include, for example, a CPU, a DSP, a microcontroller or a digital signal processor, and may also include a GPU, an embedded neural network processor (Neural-network Process Units, NPU) and an image signal processor (Image Signal Processor). Processing, ISP). The processor 710 may also include necessary hardware accelerators or logic processing hardware circuits, such as ASIC, or one or more integrated circuits for controlling the execution of the program of the technical solution of the present application. In addition, the processor 410 may have a function of operating one or more software programs, which may be stored in a storage medium.

The memory 420 of the electronic device 400 may be a read-only memory (read-only memory, ROM), other types of static storage devices that can store static information and instructions, random access memory (random access memory, RAM) or other types of dynamic storage devices that can store information and for instructions. The memory 420 can also be electrically erasable programmable read-only memory (EEPROM), compact disc read-only memory (CD-ROM) or other optical discs storage, optical disc storage (including compact discs, laser discs, optical discs, digital versatile discs, Blu-ray discs, etc.), magnetic disk storage media, or other magnetic storage devices, or can be used to carry or store desired data in the form of instructions or data structures and any computer-readable medium that can be accessed by a computer.

In accordance with various embodiments, the processor 410 and the memory 420 may be combined into one processing device, and more generally, they can be components independent of each other. During specific implementation, the memory 420 may also be integrated in the processor 410 or be independent of the processor 410.

The display device 430 may include a driving unit and a display screen. The processor 410 outputs display instructions to the drive unit, and the drive unit analyzes the display instructions, converts them into display signals, and outputs them to the display screen, thereby driving the display screen for display.

Furthermore, the devices, devices, and modules described in the embodiments of the present application may be implemented by computer chips or entities, or by products with certain functions.

Those skilled in the art should understand that the embodiments of the present application may be provided as methods, devices, or computer program products. Accordingly, the present invention can take the form of an entirely hardware embodiment, an entirely software embodiment, or an embodiment combining software and hardware aspects. Furthermore, the present invention may take the form of a computer program product embodied on one or more computer-usable storage media having computer-usable program code embodied therein.

In accordance with various embodiments, if any function is realized in the form of a software function unit and sold or used as an independent product, it can be stored in a computer-readable storage medium. Based on this understanding, the whole or part of the technical solution can be embodied in the form of a software product, and the computer software product can be stored in a storage medium, including that various instructions can be used to make a computer device (which may be a personal computer, a server, or a network device, etc.) to execute all or part of the steps of the methods described in the various embodiments of the present application.

In accordance with various embodiments, a computer program can be stored in a computer-readable storage medium, and when it is run on a computer, it can cause the computer to execute the method provided in various embodiments of the present application.

In accordance with various embodiments, a computer program product can include a computer program, and when running on a computer, can cause the computer to execute the method provided in the embodiment of the present application.

The description of the embodiments is provided with reference to the flowcharts and/or block diagrams of the methods, devices (apparatus), and computer program products according to the embodiments of the present application. It should be understood that each procedure and/or block in the flowchart and/or block diagram, and a combination of procedures and/or blocks in the flowchart and/or block diagram can be realized by computer program instructions. These computer program instructions may be provided to a general purpose computer, special purpose computer, embedded processor, or processor of other programmable data processing equipment to produce a machine such that the instructions executed by the processor of the computer or other programmable data processing equipment can produce an apparatus for realizing the functions specified in one or more procedures of the flowchart and/or one or more blocks of the block diagram.

These computer program instructions may also be stored in a computer-readable memory capable of directing a computer or other programmable data processing apparatus to operate in a specific manner, such that the instructions stored in the computer-readable memory produce an article of manufacture comprising instruction means. The device for instructions can realize the function specified in one or more procedures of the flowchart and/or one or more blocks of the block diagram.

These computer program instructions can also be loaded onto a computer or other programmable data processing device, causing a series of operational steps to be performed on the computer or other programmable device to produce a computer-implemented process, thereby provide steps for implementing the functions specified in the flow chart or blocks of the flowchart and/or the block or blocks of the block diagrams as instructions to be executed on the computer or other programmable data processing device.

It should also be noted that in the embodiments of the present application, “at least one” refers to one or more, and “multiple” refers to two or more. “And/or” describes the association relationship of associated objects, indicating that there may be three kinds of relationships, for example, A and/or B may indicate that A exists alone, A and B exist simultaneously, or B exists alone. Among them, A and B can be singular or plural. The character “/” generally indicates that the contextual objects are an “or” relationship. “At least one of the following” and similar expressions refer to any combination of these items, including any combination of single items or plural items. For example, at least one of a, b, and c can represent: a, b, c, a and b, a and c, b and c or a and b and c, where a, b, c can be single, or can be multiple.

In the embodiments of the present application, the term “comprising” or any other variant thereof is intended to cover a non-exclusive inclusion, so that a process, method, commodity or device comprising a series of elements not only includes those elements, but also includes other elements not expressly listed, or elements inherent in the process, method, commodity, or apparatus are also included. Without further limitations, an element defined by the phrase “comprising a . . . ” does not exclude the presence of additional identical elements in the process, method, article or apparatus comprising said element.

This application may be described in the general context of computer-executable instructions, such as program modules, being executed by a computer. Generally, program modules include routines, programs, objects, components, data structures, etc. that perform particular tasks or implement particular abstract data types. The application may also be practiced in distributed computing environments where tasks are performed by remote processing devices that are linked through a communications network. In a distributed computing environment, program modules may be located in both local and remote computer storage media including storage devices.

Each embodiment in the present application is described in a progressive manner, the same and similar parts of each embodiment can be referred to each other, and each embodiment may focus on the differences from other embodiments. For example, due to the similarity between the device embodiment and the method embodiment, the description for the device embodiment may be relatively simple, and for relevant parts, please refer to part of the description of the method embodiment.

Those of ordinary skill in the art can appreciate that each unit and algorithm step described in the embodiments of the present application can be realized by a combination of electronic hardware, computer software, and electronic hardware. Whether these functions are executed by hardware or software depends on the specific application and design constraints of the technical solution. Skilled artisans may use different methods to implement the described functions for each specific application, but such implementation should not be regarded as exceeding the scope of the present application.

Those skilled in the art can clearly understand that for the convenience and brevity of description, the specific working process of the devices, devices and units described above can refer to the corresponding process in the foregoing method embodiments, and details are not repeated here.

The foregoing is only a specific implementation of the present application. Any person skilled in the art within the technical scope disclosed in the present application can easily think of changes or substitutions, which should be covered by the protection scope of the present application.

What is claimed is:

1. An image display method, comprising:
displaying a first image window, wherein the first image window displays a first picture, and the first picture is a partial frame of a panoramic shot image; and
displaying a second image window, wherein the second image window displays a second picture, the second picture is a part or a whole picture of the panoramic shot image, and wherein there is content difference between the second picture and the first picture.

2. The method according to claim 1, wherein the corresponding area of the second picture includes a corresponding area of the first picture on the panoramic shot image.

3. The method according to claim 2, wherein the second picture is a whole frame of the panoramic shot image.

4. The method according to claim 2, wherein the corresponding area of the first picture is marked in the second picture.

5. The method according to claim 1, wherein the second image window is smaller than the first image window, and the second image window is displayed floatingly above the first image window.

6. The method according to claim 5, wherein the first image window is a full-screen display window.

7. The method according to claim 1, further comprises:
transforming image content of the first image according to a user's perspective transformation operation.

8. The method according to claim 1, wherein the second picture is positionally associated with the first picture.

9. The method according to claim 1, wherein a viewing angle corresponding to the second picture and a viewing angle corresponding to the first picture are set to opposite viewing directions.

10. The method according to claim 1, wherein a snapshot is taken on content of the first picture after a user performs a shooting operation.

11. An electronic device, comprising:
a memory for storing computer program instructions,
a processor for executing computer program instructions, and
a display device, wherein when the computer program instructions are executed by the processor, triggering the display device to execute the steps comprising:
displaying a first image window, wherein the first image window displays a first picture, and the first picture is a partial frame of a panoramic shot image; and
displaying a second image window, wherein the second image window is configured to display a second picture, the second picture is a part or a whole picture of the panoramic shot image, and wherein there is content difference between the second picture and the first picture.

12. The electronic device according to claim 11, wherein the corresponding area of the second picture includes a corresponding area of the first picture on the panoramic shot image.

13. The electronic device according to claim 12, wherein the second picture is a whole frame of the panoramic shot image.

14. The electronic device according to claim 12, wherein the corresponding area of the first picture is marked in the second picture.

15. The electronic device according to claim 11, wherein the second image window is smaller than the first image window, and the second image window is displayed floatingly above the first image window.

16. The electronic device according to claim 15, wherein the first image window is a full-screen display window.

17. The electronic device according to claim 11, wherein image content of the first picture is transformed according to a user's perspective transformation operation.

18. The electronic device according to claim 11, wherein a viewing angle corresponding to the second picture and a viewing angle corresponding to the first picture are set to opposite viewing directions.

19. The electronic device according to claim 11, wherein a snapshot is taken on content of the first picture after a user performs a shooting operation.

20. A non-transitory computer-readable storage medium that stores one or more computer programs, wherein when the one or more computer programs are executed by one or more processors, cause the one or more processors to perform the steps comprising:
displaying a first image window, wherein the first image window displays a first picture, and the first picture is a partial frame of a panoramic shot image; and
displaying a second image window, wherein the second image window displays a second picture, the second picture is a part or a whole picture of the panoramic shot image, and wherein there is content difference between the second picture and the first picture.
